(19) United States
(12) Patent Application Publication
(10) Pub. No.: US 2005/0200513 A1
(43) Pub. Date: Sep. 15, 2005

(54) Anti fraud card system

(76) Inventors: Bruno Boily, Montreal (CA); Jean-Francois Migneault, Montreal (CA)

Correspondence Address: INVENTARIUM;Suite 1607, 4050 rosemont blvd, Montreal, QC, H1X 1M4, CA

(21) Appl. No.: 10/799,517

(22) Filed: Mar. 12, 2004

(51) Int. Cl. H04L 17/02; H04Q 1/00

(52) U.S. Cl. 341/176

(57) ABSTRACT

An anti fraud card system consists of two physically distinct components: The first is a card having a built-in battery; an infrared receiver; a processor; a non-volatile memory; and a strip to receive a signal from the processor which is captured by a card swipe machine. The second is a compact, easily disguisable transmitter which comprises a processor; a battery; a non-volatile memory; and an infrared transmitter. Besides the two above mentioned physical components, a third important component is the user who inputs a secret sequence into the transmitter so that the transmitter in fact transmits two codes, one contained in memory inside the transmitter and the other in the memory of the user which inputs a memorized sequence using buttons on the transmitter. These two codes combine with a third code contained in the memory of the card. The user also controls the duration that the signal from the transmiter transmits over to the card by the duration he depresses the transmit button.

### BACKGROUND OF THE INVENTION

1. Field of the Invention

The invention relates generally to anti theft/anti fraud systems but more particularly to a combination transmitter/card that prevents unauthorized use of a card such as a debit, credit, access, or identification card.

2. Background of the Invention

In recent years, frauds, mostly on credit card have made the news more often than the credit card companies would have liked. Despite the implementation of various security protocols, fraud is still prevalent.

Such a large scale problem has attracted the attention of several inventors who have proposed various fraud prevention methods.

The low cost of integrated circuits allows for such circuits to be embedded within a standard card. This allows for a user to use a keypad on the card itself and input a

PIN which would enable transaction on the card.

More sophisticated systems involve the use of GPS to locate a stolen or lost card.

The weakness in using cards with built in keypads is that once the PIN is known, anyone, including fraudulous eavesdropper can steal and then use the card.

### SUMMARY OF THE INVENTION

This instant invention uses two physically distinct and separate entities, each having only one half of the complete code necessary for enabling a transaction.

It is a first object of this invention to provide for an anti fraud card system that does not require any new hardware at the point of sale.

It is a second object of this invention to provide for an anti fraud card system with a card that transmits its information in a way that is compatible with magnetic card readers at the point of sale.

It is a third object of this invention to provide for an anti fraud card system that has a low manufacturing cost for both the credit card and the transmitter.

It is a fourth object of this invention to provide for an anti fraud card system that is easy to use by end user.

It is a fifth object of this invention to provide for an anti fraud card system that is easy to use by the vendor at the point of sale.

In order to do so, the system consists of two physically distinct components: The first is a card having a built-in battery; an infrared receiver; a processor; a non-volatile memory; and a strip to receive a signal from the processor which is captured by a card swipe machine. The second is a compact, easily disguisable transmitter which comprises a processor; a battery; a non-volatile memory; and an infrared transmitter. Although an RF signal could be used in lieu of an infrared signal, all without departing from the scope of this invention, infrared is preferred because of its line of sight requirement which makes it more difficult to hide an illicit signal interceptor unlike an RF signal which can have an illicit interceptor hidden behind a wall or other physical barrier. Besides the two above mentioned physical components, a third important component is the user who inputs a secret sequence into the transmitter so that the transmitter in fact transmits two codes, one contained in memory inside the transmitter and the other in the memory of the user which inputs a memorized sequence using buttons on the transmitter. These two codes combine with a third code contained in the memory of the card. The user also controls the duration that the signal from the transmiter transmits over to the card by the duration he depresses the transmit button.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

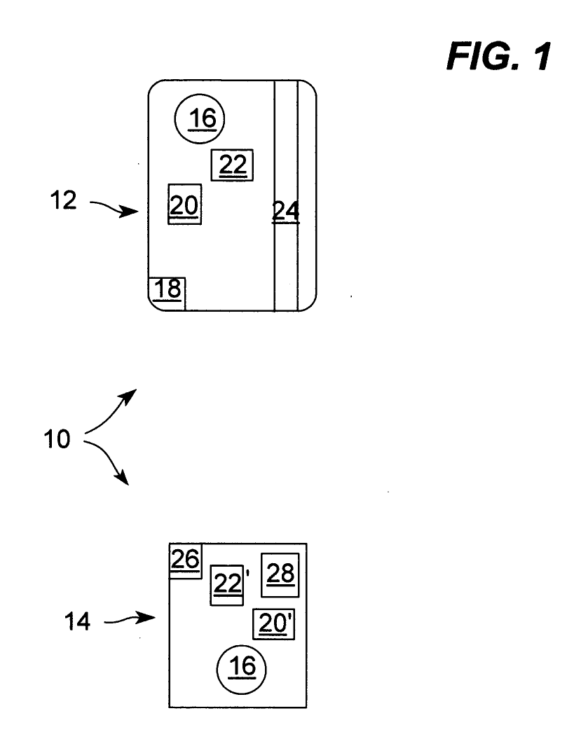

FIG. 1 Sschematic representation of a card and a pocket transmitter.

### DETAILED DESCRIPTION OF THE PREFERRED EMBODIMENT

An anti fraud card system (10) is comprised of two physical components: A card component (12) and a transmitter (14) component, each having a part of the full ID code needed to complete a transaction embedded in a non-volatile memory module (22). Each of these components carry a third of the code, the third part of the code resides in the user himself who memorizes a sequence which will be explained later.

The card component (12) has a built-in battery (16) which has enough charge to last until the card is replaced, which is generally every 2 years; an IR receiver (18) which consists of a photocell sensitive to that frequency range; a CPU (20) to handle the received IR signal from the IR receiver (18), process it to extract the part of the ID code information from the signal, combine it with the other part of the ID code contained in its own non-volatile memory module (22). Once the information is complete, it is once more processed so that it can be sent out to a signal strip (24) in a recognizable pattern readable by a standard magnetic strip reader (not shown) such as those used by card swipe machines.

The transmitter (14) is integrated into any of a variety of objects that a user would carry such as a key holder, lipstick, pager, cellphone, remote car starter, etc. . . . The transmitter (16) has much of the same components as the card (12), that is the CPU (20′); battery (16); non-volatile memory (22′); but an infrared transmitter module (26) in lieu of an IR receiver (18) and consisting of an LED, as is well known in the art. The transmitter (14) also has a keypad (28) with at least two buttons (with three being preferred) which are depressed according to a given sequence. This sequence is what the user programs in and memorizes. For example, a sequence can be to press twice on the first button, once on the second button, again on the first button and then once on the third button. This sequence is in fact a PIN that is the first part of the code which is sent along with the second part of the code over to the card (12) for a span of time between when a first button on the keypad (28) is depressed until the last button in the sequence is released. The user observes the merchant swiping the card and as soon as the card (12) is swiped, the user can release the button. The short duration of the signal makes it even harder for an illicit interceptor to intercept the signal or for a vendor to illicitly swipe the card (12) again to copy the code. Moreover, if a user inputs the wrong sequence more than a preset number of times, the card is automatically invalidated, this reduces the probability of an illicit user to find the proper sequence, this measure is well known in the art and is used for password entry on websites, at ATM machines, and for any other such types of secured transactions.

When using this system of card (12)/transmitter (14), the user hands out his card (12) to a vendor, starts the sequence and holds the last button until the vendor has swiped the card, this allows for the first two parts of the code to be transmitted by IR over to the card (12). The transmitted code is received by the IR receiver (18) which sends it as an electrical signal to the card's CPU (20) which then processes the signal to extract the information, combine it with the rest of the information contained in the non-volatile memory module (22′) that holds the third part of the code. Once the three parts of the code is combined, it creates an ID code which is once more processed so that it can be sent out to a signal strip (24) in a recognizable pattern readable by a standard magnetic strip reader (not shown) such as those used by card swipe machines. As soon as the transmitter (14) stops sending the signal, the CPU (20) that is in the card (12) erases the two code parts sent by the transmitter (14) and ceases to send a signal to the signal strip (24). Not receiving any code from the signal strip (24) the swipe machine sends an error message which makes the card (12) unusable until the correct sequence is once again input into the transmitter (14). In a different embodiment, a preset duration for the signal could be integrated into the transmitter so that the signal could be sent for a few predetermined seconds after the last button is released. Although this variation may be easier for the user, it could be considered less secure.

1. A method of using an anti fraud card system comprising a card component and a transmitter component both physically separate and distinct from each other and comprised of a built-in battery, a CPU to handle various processes, a non-volatile memory to hold coding information, with said card component further comprising a signal strip and a receiver while said transmitter further comprising a transmitter module and having the following improvement on the method of use:
a user hands out his card to a vendor, when a vendor is about to swipe said card, said user activates a first third of a code by pressing a button sequence on a keypad;
said button sequence also triggers a second third of a code and both codes are transmitted from said transmitter over to said card and said CPU inside said card processes said codes and combines it with a third part of a code contained in said card's own non-volatile memory module in order to create a complete ID code;
said ID code is processed so as to be sent out to a signal strip in a recognizable pattern readable by a standard magnetic strip reader handled by said vendor;
as soon as said transmitter stops sending said signal, said CPU that is in said card erases said code parts sent by said transmitter and ceases to send the signal to said signal strip to render said card unusable.

2. An anti-fraud card system as in claim 1 wherein:
said transmitter transmits an IR signal and said card receives an IR signal.

3. An anti-fraud card system as in claim 1 wherein:
when said user releases the last button, said transmitter ceases to send the signal to said signal strip to render said card unusable.

4. An anti-fraud card system as in claim 1 wherein:
when said user releases the last button, the signal continues to be sent for a preset duration.

5. An anti-fraud card system as in claim 1 wherein:
said transmitter has a keypad having three buttons.
